(19) United States
(12) Patent Application Publication
(10) Pub. No.: US 2011/0024219 A1
(43) Pub. Date: Feb. 3, 2011

(54) OMNI ROTATIONAL DRIVING AND STEERING WHEEL

(75) Inventors: Rasmus Nyholm Jorgensen, Haldrup (DK); Jorgen Maagaard, Ostbirk (DK)

Correspondence Address: KNOBBE MARTENS OLSON & BEAR LLP, 2040 MAIN STREET, FOURTEENTH FLOOR, IRVINE, CA, 92614, US

(73) Assignee: Aarhus Universitet, DK-8000 Arhus C (DK)

(21) Appl. No.: 12/599,250

(22) PCT Filed: May 9, 2008
(86) PCT No.: PCT/DK08/50103

§ 371 Date: Aug. 25, 2010

(30) Foreign Application Priority Data
May 10, 2007 (DK) PA 2007 00729

(51) Int. Cl. B60K 17/30; F16H 57/08

(52) U.S. Cl. 180/252; 475/336

(57) ABSTRACT

There is disclosed a driving and steering wheel (112) module (102) with an omni rotational part (106), the module comprising a flange part (104) fixable on a robot, and the omni rotational part (106) comprises an upper omni rotational part (105) and a driving and steering wheel part (108), where the omni rotational part (106) is provided for infinite rotation relative to the flange part (104) by both a drive motor (110) and a steering motor (114) being positionable on the flange part (104), and the driving and steering wheel part (108) is suspended from the upper omni rotational part (105) with a suspension (116) such that wheel part (108) can move relatively to the upper omni rotational part (105) in a suspension direction (118), and a reduction gear (120) for gearing the drive torque is provided in the wheel part (108) in order e.g. to assure traction on various surfaces and at various loads.

### FIELD OF THE INVENTION

The invention relates to a driving and steering wheel module and in particular to such a wheel module for an agricultural robot or a similar application.

### BACKGROUND OF THE INVENTION

Applications, such as wheel driven carts and such as a wheel driven robot are used indoors as well as outdoors. Although useful for various such applications, the present invention will be explained in connection with wheel driven agricultural robots. The wheel driven agricultural robots may as examples be used for automated soil preparation, soil working and plant nursing, or cutting of grass on urban areas.

GB 2 276 854 discloses an omni directional drive and steering unit where a vehicle is driven by one or more drive units each having a pair of wheels which are driven independently, e.g. by respective electric motors and gearboxes. The motors may be mounted on plates via telescopic suspension elements. The or each drive unit is thus rotated about a steering axis by the torque resulting from the differential drive forces. A control system monitors the rotation of the drive unit about the steering axis and other relevant variables, in order to control the motion of the drive unit relative to the driven surface.

In the view of the present inventors, the omni directional drive and steering unit of GB 2 276 854 suffers from one or more of the following examples of disadvantages. The omni directional drive and steering unit of GB 2 276 854 is not able to provide multiple rotation of the drive unit. The omni directional drive and steering unit of GB 2 276 854 has a relatively high mass which is suspended. Alternatively or additionally to these possible disadvantages of the omni directional drive and steering unit of GB 2 276 854, the drive motors disclosed in GB 2 276 854, if exchangeable, must e.g. be exchanged with drive motors of similar dimensions and fitted to the given suspension.

The inventors of the present invention has appreciated that an improved driving an steering wheel module is of benefit, and has in consequence devised the present invention.

### SUMMARY OF THE INVENTION

It may be seen as an object of the present invention to provide an improved omni rotational driving and steering wheel module. Preferably, the invention alleviates, mitigates or eliminates one or more of the above or other disadvantages singly or in any combination.

Accordingly there is provided, a driving and steering wheel module with an omni rotational part 106, the module comprising
a flange part fixable on an application, which application is to be steered and driven by the driving and steering wheel module, and
the omni rotational part comprises an upper omni rotational part and a driving and steering wheel part, where
the omni rotational part is provided for infinite rotation relative to the flange part by both a drive motor for providing a driving torque for driving the driving wheel and a steering motor for rotating the omni rotational part being positionable on the flange part, and
the driving and steering wheel part is suspended from the upper omni rotational part with a suspension such that the driving and steering wheel part can move relatively to the upper omni rotational part in a suspension direction, and
a reduction gear for gearing the drive torque is provided in the driving and steering wheel part in order to assure transferral of traction onto various surfaces and at various loads.

Thus, an improved driving and steering wheel module is provided. By positioning both the drive motor and the steering motor on the flange part, and by providing the module with a suspension such that the combined driving and steering wheel part can move relatively to the upper omni rotational part while providing a reduction gear in the driving and steering wheel part, a possible advantage is that a compact wheel module is provided where both a relative high driving and steering torque can be provided while traction of the driving and steering wheel is also provided. Especially, a wheel module is provided which is simple and yet effective, especially under varying driving conditions. Varying driving conditions are as an example present when the wheel module is used for an agricultural robot for everyday outdoor use. These conditions may encompass the presence of stones, mud, water and ice along with level changes.

By positioning both the drive motor and the steering motor on the flange part, a possible advantage is that any wiring of the motors does not prevent the omni rotational part of the module from continuous rotation. By positioning both the drive motor and the steering motor on the flange part, a possible advantage is that a relatively high driving and steering torque can be provided, e.g. in that these two motors are fixed to each other on the same part of the wheel module. Another possible advantage of the wheel module is that transferral of the relatively high driving and steering torque is provided through the suspension, and with help of the reduction gear provided in the driving and steering wheel part.

A possible advantage by providing the reduction gear in the driving and steering wheel part is that a reduced torque is transferred where the driving and steering wheel part move relatively to the upper part of the omni rotational part, thus assuring that the suspension works, and hereby that traction on various surfaces and at various loads, conditions and torques is provided.

In accordance herewith, the reduction gear is a gear of one or more of the following types of gears; a planet gear, a sun gear, a bevel gear pinion which drives a bevel gear wheel, chosen so that the required suspension freedom is provided while also considering the rotation speed of the driving motor, the wheel diameter, the various torques and e.g. the various surface conditions. Possibly, the reduction gear is a multi stage gear including a planet gear or a sun gear and a bevel gear pinion which drives a bevel gear wheel.

When at least part of the reduction gear is provided in a wheel hub of the driving and steering wheel part, a possible advantage is that a compact solution is provided.

When transferral of the driving torque through the suspension is provided by a multiple spline shaft connection, a possible way of enabling suspension between the driving and steering wheel part and the upper omni rotational part is provided. Furthermore, when transferral of the driving torque through the suspension is provided by a multiple spline shaft connection, a possible advantage is that a rather stiff suspension and torque transferral construction is provided. A possible advantage hereby is that the driving and steering wheel part may be suspended on one side only of the driving and steering wheel. When the driving and steering wheel part is suspended on one side only of the driving and steering wheel, a possible advantage may be that a simple construction is provided for which e.g. a wheel thickness may be changed without having to change a distance between two ‘suspension arms’. Accordingly, the suspension may be arranged and integrated in a single side suspension arm.

When the suspension arm comprises two sub-suspension arms arranged in a distance from a centreline of the omni rotational driving and steering wheel module, a possible advantage is that a compact driving and steering wheel module is provided.

When a gear ratio of the reduction gear is at least 1:15, or at least 1:24 or at least 1:30, a possible advantage may be that a relatively cheap and fast running electrical driving motor along with a wheel with a relative large diameter may be used while assuring that the suspension is still working. A relatively large wheel diameter is a wheel diameter which is larger than a typical driving and steering wheel for a typical fork-lift truck.

When the driving and steering wheel module furthermore includes an absolute and infinite angle measurement device for the steering angle and/or a rotational driving speed measurement device provided on the flange part, a possible advantage is that a good measurement result may be achieved with relatively cheap devices relative to positioning the devices in the wheel part. Still further, a possible continuous rotation of the omni rotational part is hereby obtained.

In a second aspect of the invention there is provided an application, such as a robot, which application includes the herein described driving and steering wheel module.

In general by writing that ‘it is an advantage’ by the present invention and referring to an advantage, it must be understood that this advantage may be seen as a possible advantage provided by the invention, but it may also be understood that the invention is particularly, but not exclusively, advantageous for obtaining the described advantage.

In general the various aspects and advantages of the invention may be coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

An embodiment of the invention will be described, by way of example only, with reference to the drawings, in which

FIG. 1 shows a side view of the wheel module with cross-sectional line A-A, and

FIG. 2 shows a cross-sectional view along line A-A shown in FIG. 1, and

FIG. 3 shows a wheel module in accordance with an embodiment of the invention in a perspective 3D view, and

FIG. 4 shows a flange part and an upper omni rotational part in a perspective view seen from the upper omni rotational part, and

FIG. 5 shows the flange part and the upper omni rotational part in a perspective side view, and

FIG. 6 shows the driving and steering wheel part in a perspective side view.

### DESCRIPTION OF EMBODIMENTS

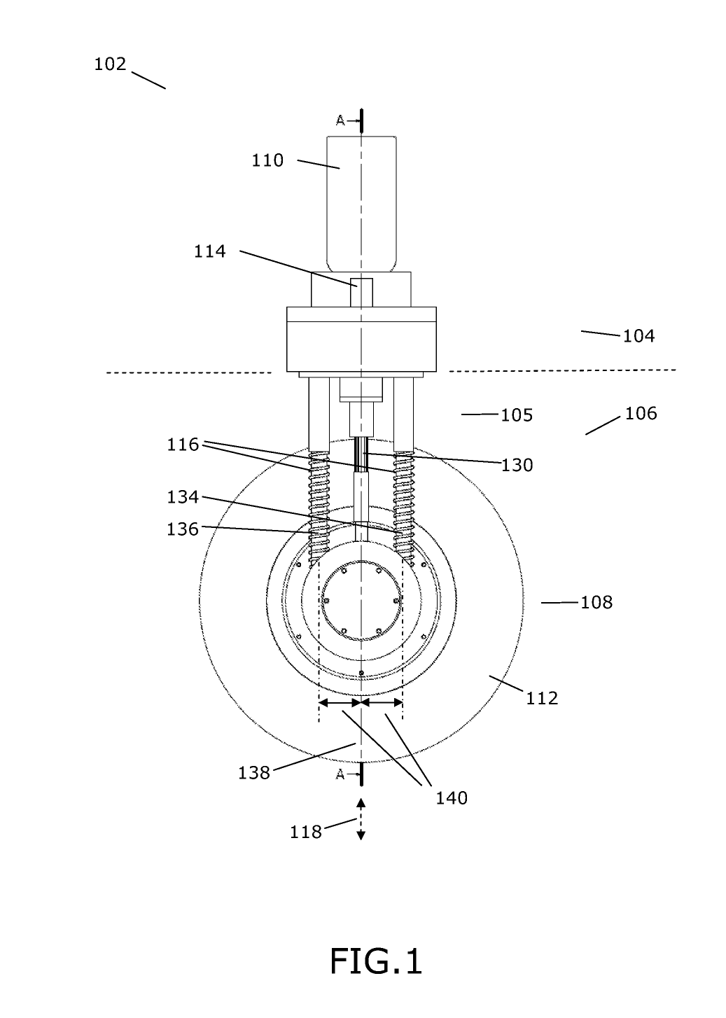

FIG. 1 illustrates an embodiment in accordance with the invention. The figure shows a side view of the wheel module with cross-sectional line A-A along a centreline 140 of a driving and steering wheel 112 module 102. The driving and steering wheel module 102 is fixable on an application (not shown), which application is to be steered and driven by the driving and steering wheel module. The application may be an agricultural robot or a similar application with one or more wheels.

It can be seen from the figure that the module includes an omni rotational part 106, which omni rotational part 106 is split up in an upper omni rotational part 105 and a driving and steering wheel part 108. Both the upper omni rotational part 105 and the driving and steering wheel part 108 are commonly rotatable with respect to the flange part 104. A rotation angle of the omni rotational part 106 may be more than 360 degrees and a number of full rotations in one rotation direction need not be registered in that the omni rotational part can be rotated as many times as wanted relative to the flange part 104. This is among others due to both a drive motor 110 for providing a driving torque for driving the driving wheel 112 and a steering motor 114 for rotating the omni rotational part are positioned on the flange part 104, and hereby e.g. no electrical lines prevent infinite rotation of the omni rotational part 106 relative to the flange part 104.

The figure shows that the driving and steering wheel part 108 is suspended from the upper omni rotational part 105 with a suspension 116 such that the driving and steering wheel part 108 can move relatively to the upper omni rotational part 105 in a suspension direction 118. The suspension direction 118 is parallel with a multiple spline shaft 130 providing a driving torque for the driving and steering wheel 112.

The suspension of the driving and steering wheel module 102 is provided from a suspension arm which includes two sub-suspension arms 134, 136. The two sub-suspension arms 134, 136 are symmetrically arranged in a distance 140 from the centreline 138 of the omni rotational driving and steering wheel module 102.

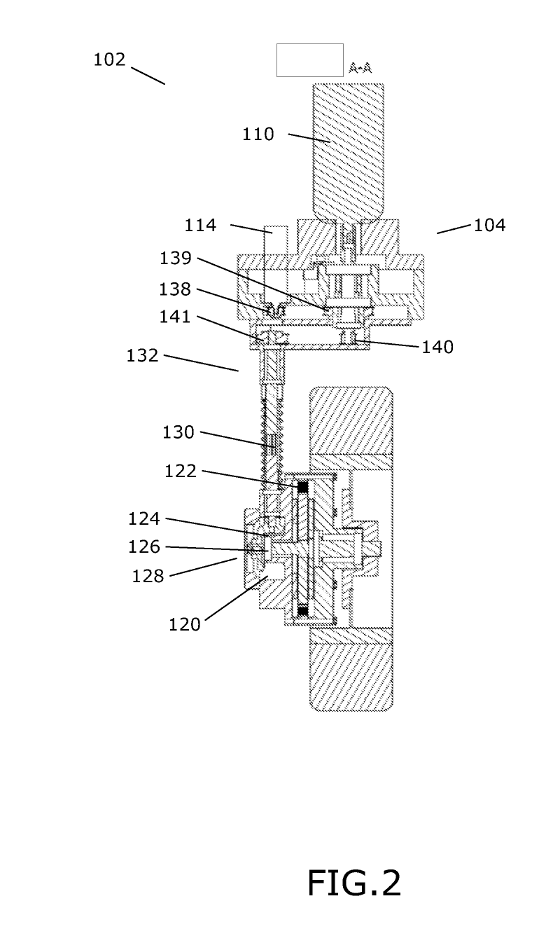

FIG. 2 shows a cross-sectional view along line A-A shown in FIG. 1. The figure shows that a reduction gear 120 for gearing the drive torque is provided in the driving and steering wheel part 108. The reduction gear includes a bevel gear pinion 124 cooperating with a bevel gear wheel 126 and a planet gear 122. Both gears are provided in the wheel hub 128. In the cross-sectional view it can be seen that only a single side of the driving and steering wheel 108 is supported to the flange part 104 via the suspension. The suspension is integrated in the one side suspension arm 132.

Transferral of steering torque from the steering motor 114 to the upper omni rotational part 105 is provided by a timming pulley 138 fixed to an axle of the steering motor 114 via a timming belt (not shown) to a timming pulley 139 fixed to the upper omni rotational part 105. Similarly, it can be seen that transferral of driving torque from a driving axle of the driving motor 110 to the multiple spline shaft 130 is provided by a timming pulley 140 fixed to the driving axle of the driving motor 110 via a timming belt (not shown) to a timming pulley 141 fixed to the multiple spline shaft 130. It can be seen that a centreline (not shown in FIG. 2) runs through a centre of a rotation of the omni rotational part 106 as well as the through a turning centre of the wheel 112.

The transferral of steering torque from the steering motor 114 to the upper omni rotational part 105 may be provided by including a differential epicyclical gear (not shown) in the connection for transferring the steering torque between the steering motor 114 and the omni rotational part 105. This may e.g. enable the use of a relative small and/or lightweight steering motor 114 while still providing an increasingly powerful rotation movement of the upper omni rotational part 105 and hereby of the complete omni rotational part 106.

Due to the relatively high gearing in the wheel hub 128 a number of different gears in order to choose different gear ratios may be provided in the module without the use of a clutch.

Positioning both the driving motor 110 and the steering motor 114 on the flange part 104 enables an easy change between different motor types such as between hydraulic and electrical motors. Still further, the construction allows for transferral of steering and/or driving torque to a further timming pulley (not shown) connected by an axle (not shown) to the timming pulley 140 and the timming pulley 139 via a timming pulley from driving means positioned outside the module.

Control of the driving speed and rotation angle may follow based on input from an absolute and infinite angle measurement device coupled to the steering motor for measuring the steering angle and from a rotational driving speed measurement device coupled to the driving motor. Both measurement devices (not shown) are provided on the flange part 104. It is preferred that all measurement and/or control devices are provided on the flange part. Furthermore, it may be preferred to use wireless transfer of any control signals to a control device on the flange part.

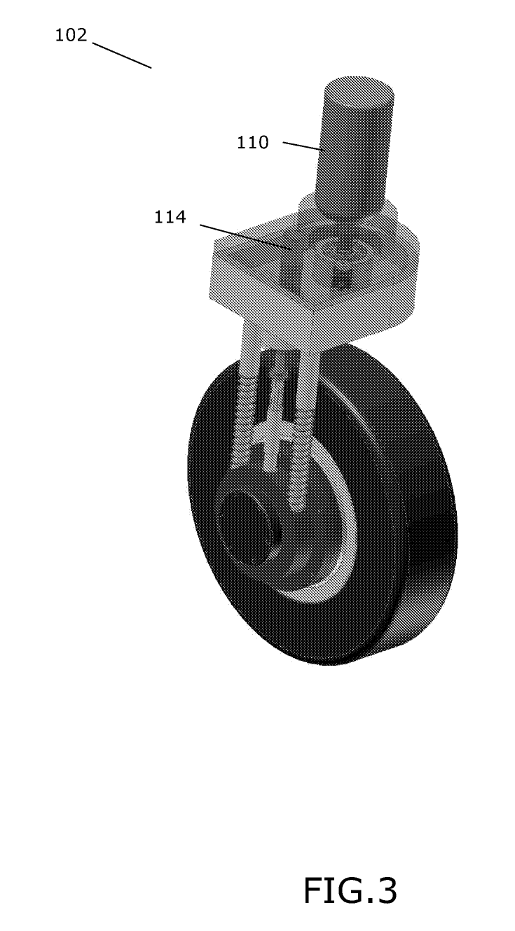

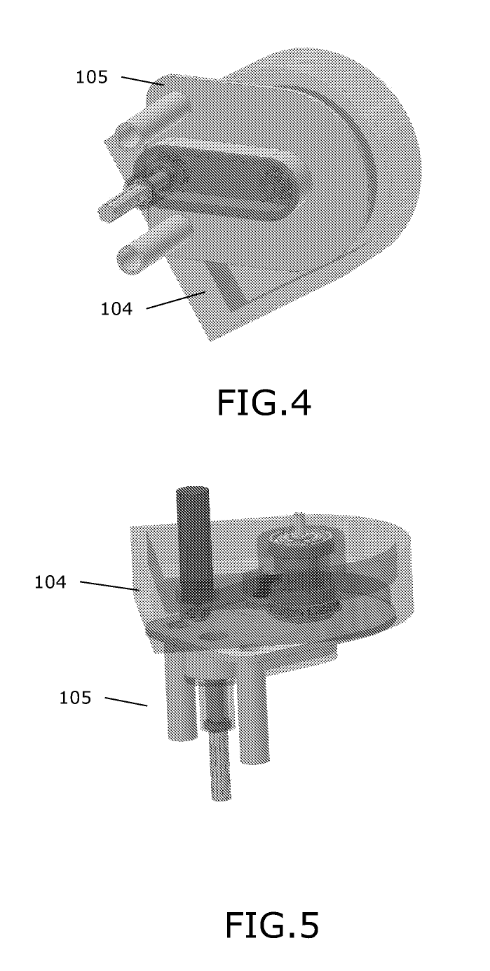

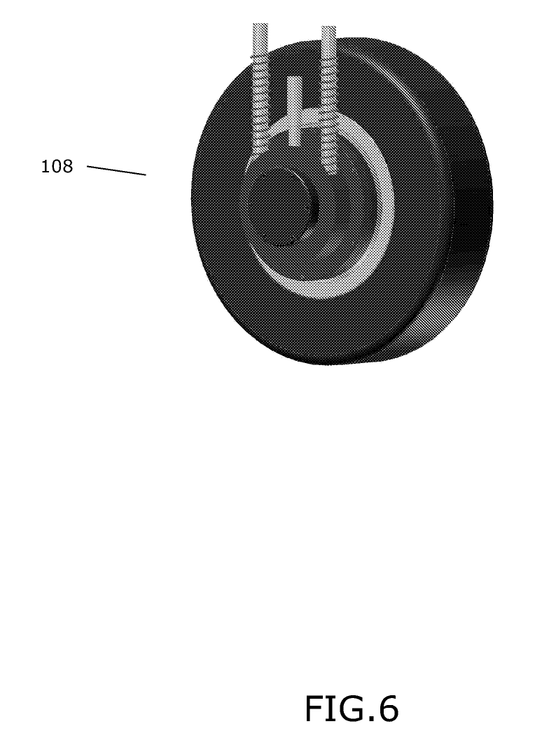

FIG. 3 shows the wheel module 102 in a perspective 3D view, and FIG. 4 shows the flange part 104 and the upper omni rotational part 105 in a perspective view seen from the upper omni rotational part 105, and FIG. 5 shows the flange part 104 and the upper omni rotational part 105 in a perspective side view, and FIG. 6 shows the driving and steering wheel part 108 which can have its steering direction rotated a multiple number of times in a perspective side view.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims, however the inclusion of the reference signs is only for clarity reasons and should not be construed as limiting the scope of the claims.

It is described that there is disclosed a driving and steering wheel 112 module 102 with an omni rotational part 106, the module comprising a flange part 104 fixable on a robot, and the omni rotational part 106 comprises an upper omni rotational part 105 and a driving and steering wheel part 108, where the omni rotational part 106 is provided for infinite rotation relative to the flange part 104 by both a drive motor 110 and a steering motor 114 being positionable on the flange part 104, and the driving and steering wheel part 108 is suspended from the upper omni rotational part 105 with a suspension 116 such that wheel part 108 can move relatively to the upper omni rotational part 105 in a suspension direction 118, and a reduction gear 120 for gearing the drive torque is provided in the wheel part 108 in order e.g. to assure traction on various surfaces and at various loads.

1. A driving and steering wheel (112) module (102) with an omni rotational part (106), the module comprising:
a flange part (104) fixable on an application, which application is to be steered and driven by the driving and steering wheel module (102), and
the omni rotational part (106), which comprises an upper omni rotational part (105) and a driving and steering wheel part (108), wherein
the omni rotational part (106) can be infinitely rotated relative to the flange part (104) by both a drive motor (110) for providing a driving torque for driving the driving wheel (112) and a steering motor (114) for rotating the omni rotational part (106) being positioned on the flange part (104), and
the driving and steering wheel part (108) is suspended from the upper omni rotational part (105) with a suspension (116) such that the driving and steering wheel part (108) can move relative to the upper omni rotational part (105) in a suspension direction (118), and
a reduction gear (120) for gearing the drive torque is provided in the driving and steering wheel part (108) in order to assure traction on various surfaces and at various loads.

2.-12. (canceled)

13. The driving and steering wheel module according to claim 1, wherein the reduction gear (120) is a gear selected from the group consisting of: a planet gear (122), a sun gear, and a bevel gear pinion (124) which drives a bevel gear wheel (126).

14. The driving and steering wheel module according to claim 1, wherein the reduction gear (120) is a multi stage gear selected from the group consisting of a planet gear (122), a sun gear, and a bevel gear pinion (124) which drives a bevel gear wheel (126).

15. The driving and steering wheel module according to claim 1, wherein at least part of the reduction gear (122) is provided in a wheel hub (128) of the driving and steering wheel part (108).

16. The driving and steering wheel module according to claim 13, wherein the planet gear (122) or the sun gear is provided in the wheel hub (128).

17. The driving and steering wheel module according to claim 1, wherein transferral of the driving torque through the suspension (116) is provided by a multiple spline shaft (130) connection.

18. The driving and steering wheel module according to claim 1, wherein the driving and steering wheel part (108) is suspended on one side only of the driving and steering wheel (108).

19. The driving and steering wheel module according to claim 1, wherein the suspension is arranged and integrated in a single side suspension arm (132).

20. The driving and steering wheel module according to claim 19, wherein the suspension arm (132) comprises two sub-suspension arms (134, 136) arranged in a distance (140) from a centerline (138) of the omni rotational driving and steering wheel module (102).

21. The driving and steering wheel module according to claim 1, wherein a gear ratio of the reduction gear (120) is at least 1:15, at least 1:24 or at least 1:30.

22. The driving and steering wheel module according to claim 1, further comprising an absolute and infinite angle measurement device for the steering angle or a rotational driving speed measurement device provided on the flange part (104).

23. An application comprising an omni rotational driving and steering wheel module (102) according to claim 1.
